(19) United States
(12) Patent Application Publication
(10) Pub. No.: US 2012/0129986 A1
(43) Pub. Date: May 24, 2012

(54) USE OF AMINES IN COMBINATION WITH ACRYLIC POLYMERS IN THE MANUFACTURE OF AQUEOUS SUSPENSIONS OF MINERAL MATTERS

(75) Inventor: Jacques MONGOIN, Quincieux (FR)

(73) Assignee: COATEX S.A.S., Genay (FR)

(21) Appl. No.: 13/299,439

(22) Filed: Nov. 18, 2011

Related U.S. Application Data
(60) Provisional application No. 61/415,985, filed on Nov. 22, 2010.

(30) Foreign Application Priority Data
Nov. 19, 2010 (FR) 10 04502

(51) Int. Cl. C08K 5/3462; C08K 5/17

(52) U.S. Cl. 524/92; 524/251; 524/247; 524/249

(57) ABSTRACT

The use of an amine in a method to manufacture an aqueous suspension of mineral matter by dispersion and/or grinding in the presence of at least one acrylic polymer. The amine enables the quantity of polymer dispersant to be reduced. In a preferred embodiment the quantity of acrylic dispersant is reduced, whilst keeping the same mineral matter content, and maintaining or even improving the rheology of the suspension over time.

### REFERENCE TO PRIOR APPLICATIONS

This application claims priority to U.S. provisional application Ser. No. 61/415,985, filed Nov. 22, 2010; and to French patent application 10 04502, filed Nov. 19, 2010, both incorporated herein by reference.

### FIELD OF THE INVENTION

The present invention relates to agents useful to disperse or to aid grinding of mineral matter in a wet medium, and to processes of producing aqueous suspensions of mineral matter by dispersion and/or grinding.

The invention enables one of ordinary skill in the art to minimize the quantity of acrylic polymers, which are commonly used in these operations, without however impairing the stability and dry extract of the aqueous suspensions of mineral matters manufactured in this manner. The invention is, in a preferred embodiment, based on the use of amines in combination with acrylic polymers. In a surprising and advantageous manner, it is possible to reduce the quantity of acrylic polymers used, whilst maintaining the abovementioned properties at a level at least equivalent to that obtained without the addition of amines in the conditions specified by the present invention.

### BACKGROUND OF THE INVENTION

In describing the background of the invention it is the intention of the inventor to prime the reader for a greater understanding of the invention. In doing so certain documents, patents, etc. are described. These documents speak for themselves, and although the discussion of their contents herein is believed to be accurate, any inadvertent mischaracterization does not constitute an admission.

The mineral industry is a large consumer of chemicals. They are used in the various steps of transformation/modification/processing to which mineral matter is subject. Thus, in the case of calcium carbonate of natural or synthetic origin, the skilled man in the art undertakes many operations known as “grinding” operations (reduction of the granulometric size of the particles) when dry or, more frequently, in a wet medium, or “dispersion” operations (suspension of the particles in a liquid).

Both these operations are made easier through the use, respectively, of grinding aid agents and dispersant agents. The role of the grinding agents is to minimise the yield stress of the suspension during the grinding operation, in such a way as to increase the productivity of the grinder; by this means the mechanical action of attrition and fragmentation of the particles is facilitated. Concerning the dispersant agents, they enable the viscosity of a suspension to be maintained within acceptable ranges as mineral matters are introduced into it; this enables the dry extract to be increased, whilst retaining a sufficiently low level of viscosity to handle the suspension and to store it without risk of sedimentation.

The art is particularly rich on the subject of such additives. For many years, it has been known that homopolymers of acrylic acid constitute efficient agents to aid dispersion or grinding in a wet medium of calcium carbonate. As a reference, one may refer to the documents FR 2 539 137 A1, FR 2 683 536 A1, FR 2 683 537 A1, FR 2 683 538 A1, FR 2 683 539 A1 and FR 2 802 830 A1, FR 2 818 165 A1, which illustrate many variants of these homopolymers, in accordance with their molecular weight and their neutralisation.

For the same type of application, it is also advantageous to copolymerise acrylic acid with another carboxylic monomer such as, for example, methacrylic acid or maleic acid (see on the subject documents EP 0850 685 A1 and FR 2 903 618 A1) and/or with another monomer of ethylenic unsaturation but without a carboxylic group, such as a (meth)acrylic ester: this latter variant is described in the documents cited in the previous paragraph.

This being so, from the standpoint of legislation and environmental requirements, reducing the quantity of polymer used remains a priority for the skilled man in the art, provided it is compatible with a level of performance specifications equivalent to the one obtained hitherto. Amongst these performance specifications, particular emphasis is given to the stability of the manufactured aqueous suspensions, as determined by Brookfield™ viscosity measurements at different instants, together with the final dry extract as a % by dry weight of mineral matter compared to the total weight of the suspensions.

With this regard, document FR 2 894 846 A1 teaches the use of fluorinated compounds with polyacrylates of the prior art, thus enabling their dose to be reduced in techniques of dispersion and grinding of mineral matters. Nevertheless, the fluorinated compounds remain rare and expensive products, which are themselves likely to have a negative environmental impact.

It is also known that reducing the polymolecularity index of the acrylic polymers gives the latter improved dispersion and grinding aid properties. To accomplish this, one method consists in isolating, for a given polymer, the chains of a certain molecular weight by separation techniques, whether static or dynamic, in the presence of solvents, as described in document EP 0 499 267 A1. Another means relies on the use of radical polymerisation known as “controlled” radical polymerisation (PRC). This term refers to synthesis techniques based on the use of particular chain-transfer agents, such as xanthates or trithiocarbonates (see documents EP 1 529 065 A1 and EP 1 377 615A1).

By reducing the polymolecularity index of the manufactured acrylic polymers, their ability to disperse or facilitate grinding of a mineral matter in water is increased. This is described notably in documents “Dispersion of calcite by poly(sodium acrylate) prepared by Reversible Addition-Fragmentation chain Transfer (RAFT) polymerization” (Polymer (2005), 46(19), pp. 8565-8572) and “Synthesis and Characterization of Poly(acrylic acid) Produced by RAFT Polymerization. Application as a Very Efficient Dispersant of CaCO3, Kaolin and TiO2” (Macromolecules, 36(9), 2003, pp 3066-3077).

However, these latter solutions based on separation or PRC techniques are sometimes difficult to implement: they require specific installations not necessarily available to all industrial plants. Lastly, French Patent Application FR 2 940 141 A1 is known, which relates to the neutralisation of polyacrylates by lithium hydroxide, enabling the quantity of polymer to be reduced in order to disperse and/or facilitate grinding in water of calcium carbonate. However, lithium hydroxide remains an extremely costly compound, which also poses serious environmental problems (see the provisions relating to recycling of this compound).

Providing a simple solution enabling the performance of the polyacrylates of the prior art as dispersant agents and grinding aid agents of mineral matters in an aqueous medium to be improved, i.e. enabling their quantity to be reduced for an equivalent performance level, is currently a problem which has not been resolved satisfactorily.

### SUMMARY OF THE INVENTION

Continuing its research in this field, the inventor has succeeded in developing the use of an amine, in a method of manufacture of an aqueous suspension of mineral matter by dispersion and/or grinding in the presence of at least one acrylic polymer, as an agent enabling the quantity of the polymer to be reduced, where the latter polymer is completely neutralised by an agent other than the amine.

In a completely unexpected manner, the combination between the amine and the acrylic polymer enables a mineral matter to be dispersed and/or its grinding in an aqueous medium to be facilitated in a more efficient manner than the acrylic polymer used without the amine. It is demonstrated that, for an at least equivalent level of performance (in terms of dry extract and Brookfield™ viscosity measured at 10 revolutions/minute, and for a given granulometry), the invention enables the quantity of acrylic polymer used to be reduced.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### DETAILED DESCRIPTION OF THE PREFERRED EMBODIMENTS

An example of an amine used according to the invention is AMP (2-amino-2-methyl 1-propanol; n^{o} CAS=124-68-5). In addition, according to a preferred embodiment of the invention, the amines used have the particular formula (I) which will be explained below. It is then shown that these amines proved to be more efficient than AMP, and to improve the efficiency of the dispersant system according to the parameters mentioned above. In addition, it is stated that these amines of formula (I) are already known, notably as agents allowing the tinting strength of a paint to be developed (see document WO 2009/087330 A1).

In the prior art, AMP has previously been used with an acrylic polymer to disperse a mineral matter. Reference may be made to document U.S. Pat. No. 4,370,171 A1 which teaches the combination of certain alcanolamines with acrylic polymers, with a view to dispersing calcium carbonate. According to example 1 of this document, it will be able to be observed that the claimed combination in fact consists in pre-blending the non-neutralised acrylic dispersant with an alcanolamine: in this sense, the acidic dispersant is neutralised by the alcanolamine. This is not the case with our invention, in which the acrylic polymer is completely neutralised by an agent other than the amine.

In addition, nothing in document U.S. Pat. No. 4,370,171 A1 suggests that the alcanolamines described might enable the quantity of acrylic polymer to be reduced, without affecting the performance of the dispersant system. In addition, the alcanolamine:dispersant mass ratios are between 0.5:1 and 1.5:1 in this document: this neither describes nor suggests the preferred ratio of the present invention, which is between 0.05:1 and 0.35:1. Lastly, according to a preferred characteristic of our invention which is neither disclosed nor suggested in the state of the art, compounds of (I) lead to particularly advantageous performance specifications, in terms of dry extract and rheology of the manufactured aqueous suspensions.

Thus, a first object of the present invention lies in the use of at least one amine in a method of manufacture of an aqueous suspension of mineral matter by dispersion and/or grinding in the presence of at least one acrylic polymer completely neutralised by a neutralisation agent other than an amine, as an agent enabling the quantity of the acrylic polymer to be reduced.

This use is also preferably characterised in that the amine:acrylic polymer mass ratio is between 0.05:1 and 0.35:1, and more preferentially between 0.10:1 and 0.30:1.

According to a first variant, this use is characterised in that the amine is chosen from among dimethylamine, monoethanolamine, diethanolamine, triethanolamine, N-methylethanolamine, 2-amino-2-methyl-1-propanol, triisopropanolamine, 2,3,4,6,7,8,9,10-octahydropyrimido[1,2-a]azepine (DBU; n^{o} CAS=6674-22-2), 2,2′-diazabicyclo[2.2.2]octane (DABCO; n^{o} CAS=280-57-9). In all cases herein, mixtures can be used.

In a second, more preferred variant, this use is also characterised in that the amine satisfies formula (I):

NR₁R₂R₃ (I)

where R₁, R₂, R₃ are identical or different, and chosen from among:
a linear or branched alkyl or oxyalkylated radical having 1 to 12 carbon atoms,
a cyclo-alkyl radical having 3 to 12 carbon atoms,
a linear hydroxy-alkyl radical having 1 to 6 carbon atoms,
   with the understanding that:
at most one R₂ or R₃ group represents hydrogen,
at least one of the groups R₁, R₂, R₃ includes an OH group,
at least one of the groups R₁, R₂, R₃ includes at least one branch in the a position of the nitrogen atom.

According to this variant, this use is also characterised in that, in formula (I), R₁ represents hydrogen, where R₂ and R₃ are identical or different, and chosen from among:
a linear or branched alkyl or oxyalkylated radical having 1 to 12 carbon atoms,
a cyclo-alkyl radical having 3 to 12 carbon atoms,
a linear hydroxy-alkyl radical having 1 to 6 carbon atoms,
   with the understanding that:
at most one of the groups R₂ or R₃ includes an OH group,
at least one of the groups R₂ or R₃ includes at least one branch in the a position of the nitrogen atom.

According to this variant, this use is also characterised in that, in formula (I), each alkyl or oxyalkylated or cyclo-alkyl radical includes 3 to 10, and preferentially 3 to 8, carbon atoms.

According to this variant, this use is also characterised in that, in formula (I), the radical or radicals carrying the OH group include 2 or 3, and preferentially 2, carbon atoms.

According to this variant, this use is also characterised in that, in formula (I), R₁ represents hydrogen, where R₂ and R₃ are identical or different, and chosen from among:
a linear or branched alkyl or oxyalkylated radical having 3 to 8 carbon atoms,
a cyclo-alkyl radical having 6 to 10 carbon atoms,
a linear hydroxy-alkyl radical having 2 to 3, and preferentially 2, carbon atoms,
   with the understanding that:
at least one of the groups R₂ or R₃ includes an OH group,
at least one of the groups R₂ or R₃ includes at least one branch in the a position of the nitrogen atom.

According to this variant, this use is also characterised in that the amine is chosen from among:
N-(1-methylpropyl)-N-(2-hydroxyethylamine),
N-(1,3-dimethylbutyl)-N-(2-hydroxyethylamine),
N-(1-ethyl-3-methylpentyl)-N-(2-hydroxyethylamine),
N-(3,3′,5-trimethylcyclohexyl)-N-(2-hydroxyethylamine),
N-(4-hydroxycyclohexyl)-N-(2-hydroxyethylamine).

Other amines may also be used. Included are the heavy polyamines such as piperazine, whether or not substituted, amino ethyl piperazine, whether or not substituted, amino ethyl ethanol amine, the polyether amines, the primary amines with polyethylene and/or polypropylene glycol, the ethylene amines such as 2-(diethylamino) ethyl amine, 2-(diisopropylamino) ethyl amine, pentamethyldiethylenetriamine or again N-(2-aminoethyl)ethanol amine, the propylene amines such as N3-amine (3-(2-aminoethylamino)propylamine, 1,3-diaminopropane, and the substituted morpholines such as N-ethylmorpholine or N-methylmorpholine. One may also cite the products sold under the brand Alpamine™ by the Arkema group, and specifically Alpamine™ N72.

The molecular weight of the polymers used is not restricted, but it is preferred that it is not too high, in which case the polymer acts like a thickening agent of the medium. The preferred maximum value of this molecular weight may be quantified at approximately 300,000 g/mole. In addition, the skilled man in the art knows how to regulate and modify this molecular weight; he may notably refer to the documents cited at the start of the Application, relating various acrylic polymers used to disperse or facilitate grinding in water of a mineral matter.

The invention is also characterised in that the acrylic polymer is completely neutralised by at least one neutralisation agent chosen, for example, from among the calcium or magnesium hydroxides and/or oxides, or from among sodium, potassium or lithium hydroxide and their blends.

The invention is also characterised in that the acrylic polymer is a homopolymer of acrylic acid or a copolymer of acrylic acid with another monomer.

The invention is also characterised in that, for the copolymer of acrylic acid with another monomer, this other monomer is chosen from among methacrylic acid, maleic anhydride, 2-acrylamido-2-methyl propane sulfonic acid, the phosphoric esters of the (meth)acrylates of alkylene glycol and the non-ionic monomers of formula (II):

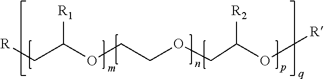

where m, n, p and q are integers and m, n, p are less than 150, q is greater than 0 and at least one integer among m, n and p is non-zero, R is a radical having a polymerisable unsaturated group, R₁ and R₂ are identical or different and represent hydrogen atoms or alkyl groups, R′ represents hydrogen or a hydrocarbonaceous radical having 1 to 40 carbon atoms, or an ionic or ionisable group.

The invention is also characterised in that the aqueous suspension, after dispersion and/or grinding, has a dry extract, expressed as a percentage by dry weight of mineral matter compared to its total weight, of between 10% and 82%, preferentially between 50% and 81%, and very preferentially between 65% and 78%.

The invention is also characterised in that the aqueous suspension has a dry weight content of acrylic polymer, compared to the total dry weight of mineral matter, of between 0.01% and 5.00%, preferentially between 0.01% and 2.00%, and very preferentially between 0.05% and 1.00%.

The invention is also characterised in that the mineral matter is chosen from among natural, synthetic or precipitated calcium carbonate, talc, kaolin and their blends, preferentially from among natural, synthetic or precipitated calcium carbonate and their blends, and is preferentially a natural calcium carbonate.

The following examples enable the invention to be illustrated, without however limiting its scope.

### EXAMPLES

All the granulometric distributions, together with the indicated diameters, are determined with a Sedigraph™ 5100 device, sold by the company MICROMERITICS™.

In all the tests, the ppm of dry products are indicated relative to the dry weight of mineral matter used.

In all tests, the carbonate is a calcite originating from Orgon.

### Example 1

This example describes the grinding of a natural calcium carbonate in water, through the use during the grinding step of a homopolymer of acrylic acid, alone or in combination with certain amines.

The grinding is performed on a laboratory device of the Dyno Mill™ type of the KDL type, where the volume of the grinding chamber is 1.4 litre, and the grinding body of which consists of 2,500 grams of corundum beads of diameter of between 0.6 and 1 mm.

In practical terms, the acrylic polymer is firstly introduced, followed by the amine, and the grinding operation is performed.

In addition, the grinding is performed using techniques well known to the skilled man in the art, and notably described in documents FR 2 539 137 A1, FR 2 683 536 A1, FR 2 683 537 A1, FR 2 683 538 A1, FR 2 683 539 A1 and FR 2 802 830 A1 and FR 2 818 165 A1.

Test n^{o} 1-a

This test illustrates the prior art and uses 3,500 ppm of a homopolymer of acrylic acid, 70% by mole of the carboxylic sites of which are neutralised by the sodium ion, and 30% by the calcium ion, and of molecular weight as determined by GPC equal to 5,500 g/mole.

Test n^{o} 1-b

This test illustrates the prior art and uses 3,500 ppm of a homopolymer of acrylic acid, all of the carboxylic sites of which are neutralised by an amine which is 2-amino-2-methyl-1-propanol, and of molecular weight as determined by GPC equal to 5,500 g/mole. This test therefore illustrates the prior art as described in document U.S. Pat. No. 4,370,171 A1 previously discussed above, in which the dispersant is previously neutralised with an alcanolamine.

Test n^{o} 2:

This test illustrates the invention and uses 3,300 ppm of a homopolymer of acrylic acid, 70% by mole of the carboxylic sites of which are neutralised by the sodium ion and 30% by the calcium ion, and of molecular weight as determined by GPC equal to 5,500 g/mole, in combination with 800 ppm of an amine of formula (I) which is N-(1-methylpropyl)-N-(2-hydroxyethylamine).

Test n^{o} 3:

This test illustrates the invention and uses 3,150 ppm of a homopolymer of acrylic acid, 70% by mole of the carboxylic sites of which are neutralised by the sodium ion and 30% by the calcium ion, and of molecular weight as determined by GPC equal to 5,500 g/mole, in combination with 800 ppm of an amine of formula (I) which is N-(1-methylpropyl)-N-(2-hydroxyethylamine).

For each of the tests n^{o} 1 to 3, the measurements of the dry extracts (DE), of the percentage by weight of particles having a diameter of less than 2 μm (%<2 μm) and Brookfield™ viscosities at 25° C. and at 10 revolutions/minute at t=0 (Bk10 t0) and at t=8 days after stirring (Bk10 t8) are given in table 1.

TABLE 1

| Test n° | 1-a | 1-b | 2 | 3 |
|---|---|---|---|---|
| Prior Art Invention | PA | PA | IN | IN |
| Dispersant (ppm) | 3,500 | 3,500 | 3,300 | 3,150 |
| Amine (ppm) | 0 | 0 | 800 | 800 |
| DE (%) | 78.3 | 78.3 | 78.4 | 78.5 |
| % <2 μm | 59 | 59 | 60 | 59.5 |
| Bk10 t0 (mPa · s) | 180 | 180 | 200 | 200 |
| Bk10 t8 (mPa · s) | 200 | 195 | 180 | 190 |

These results show that the addition of an amine enables the dose of acrylic dispersant used to be reduced, for values of Brookfield™ viscosities which are comparable and stable over time.

### Example 2

This example describes the grinding of a natural calcium carbonate in water in the presence of a homopolymer of acrylic acid and possibly an amine.

The grinding is performed under the same conditions as those described in the previous example, except for test n^{o} 8, in which the amine is introduced into the suspension, after grinding.

Test n^{o} 4:

This test illustrates the prior art and uses 4,500 ppm of a homopolymer of acrylic acid, which is completely neutralised by the sodium ion, and of molecular weight as determined by GPC equal to 5,500 g/mole.

Test n^{o} 5:

This test illustrates the invention and uses 4,500 ppm of a homopolymer of acrylic acid, completely neutralised by the sodium ion, and of molecular weight as determined by GPC equal to 5,500 g/mole, in combination with 800 ppm of an amine of formula (I) which is N-(1-methylpropyl)-N-(2-hydroxyethylamine).

Test n^{o} 6:

This test illustrates the invention and uses 4,500 ppm of a homopolymer of acrylic acid, completely neutralised by the sodium ion, and of molecular weight as determined by GPC equal to 5,500 g/mole, in combination with 800 ppm of 2-amino-2-methyl-1-propanol (AMP).

Test n^{o} 7:

This test illustrates the invention and uses 4,000 ppm of a homopolymer of acrylic acid, completely neutralised by the sodium ion, and of molecular weight as determined by GPC equal to 5,500 g/mole, in combination with 800 ppm of an amine of formula (I) which is N-(1-methylpropyl)-N-(2-hydroxyethylamine).

Test n^{o} 8:

This test illustrates the invention and uses during the grinding step 4,500 ppm of a homopolymer of acrylic acid, which is completely neutralised by the sodium ion, and of molecular weight as determined by GPC equal to 5,500 g/mole. 800 ppm of an amine of formula (I) which is N-(1-methylpropyl)-N-(2-hydroxyethylamine) was then introduced into the suspension, after grinding.

For each of the tests n^{o} 4 to 8, the measurements of the dry extracts (DE), of the percentage by weight of particles having a diameter of less than 2 μm (%<2 μm) and Brookfield™ viscosities at 25° C. and at 10 revolutions/minute at t=0 (Bk10 t0) and at t=8 days after stirring (Bk10 t8) are given in table 2.

TABLE 2

| Test n° | 4 | 5 | 6 | 7 | 8 |
|---|---|---|---|---|---|
| Prior Art Invention | PA | IN | IN | IN | IN |
| Dispersant (ppm) | 4,500 | 4,500 | 4,500 | 4,000 | 4,500 |
| Amine (ppm) | 0 | 800 | 800 | 800 | 800 |
| DE (%) | 76.0 | 76.1 | 76.2 | 76.2 | 76.2 |
| % <2 μm | 88.3 | 88.4 | 88.4 | 88.4 | 88.4 |
| Bk10 t0 | 1,570 | 770 | 770 | 800 | 790 |
| Bk10 t8 | 2,940 | 1,470 | 2,010 | 1,980 | 1,780 |

The results according to tests n^{o} 5, 6 and 8, in comparison with those obtained according to test n^{o} 4, demonstrate that the addition of an amine enables the value of the Brookfield™ viscosities to be reduced, for a given dose of acrylic dispersant. Test n^{o} 7, for its part, demonstrates that it is possible to reduce the quantity of acrylic dispersant through the addition of an amine, whilst also reducing the value of the Brookfield™ viscosities.

Finally, the amine of formula (I) used in test n^{o} 5 enables better results than with AMP according to test n^{o} 6 to be obtained. This result is even confirmed for a lower dose of acrylic dispersant in the case of the amine of formula (I), according to tests n^{o} 7 and 8.

### Example 3

This example describes the grinding of a natural calcium carbonate in water, through the use during the grinding step of a homopolymer of acrylic acid, alone or in combination with certain amines.

The grinding is performed under the same conditions as those described in example 1.

Test n^{o} 9:

This test illustrates the prior art and uses 6,500 ppm of a homopolymer of acrylic acid, 50% by mole of the carboxylic sites of which are neutralised by the magnesium ion, and 50% by the sodium ion, and of molecular weight as determined by GPC equal to 5,500 g/mole.

Test n^{o} 10:

This test illustrates the invention and uses 6,500 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 800 ppm of 2-amino-2-methyl-1-propanol (AMP).

Test n^{o} 11:

This test illustrates the invention and uses 5,850 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 800 ppm of 2-amino-2-methyl-1-propanol (AMP).

Test n^{o} 12:

This test illustrates the invention and uses 5,850 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 800 ppm of an amine of formula (I) which is N-(1-methylpropyl)-N-(2-hydroxyethylamine).

Test n^{o} 13:

This test illustrates the invention and uses 5,850 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 800 ppm of 2-aminoethanol (ethanolamine; n^{o} CAS=141-43-5).

Test n^{o} 14:

This test illustrates the invention and uses 5,850 ppm of a homopolymer of acrylic acid,
50% by mole of the carboxylic sites of which are neutralised by the magnesium ion and 50% by the sodium ion, and of molecular weight as determined by GPC equal to 5,500 g/mole, in combination with 800 ppm of 2,2′-Iminodiethanol (diethanolamine; n^{o} CAS=111-42-2).
   Test n^{o} 15:

This test illustrates the invention and uses 5,850 ppm of a homopolymer of acrylic acid,
50% by mole of the carboxylic sites of which are neutralised by the magnesium ion and 50% by the sodium ion, and of molecular weight as determined by GPC equal to 5,500 g/mole, in combination with 800 ppm of 2,2′,2″-Nitrilotriethanol (triethanolamine; n^{o} CAS=102-71-6).
   Test n^{o} 16:

This test illustrates the invention and uses 5,850 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 800 ppm of 2,3,4,6,7,8,9,10-octahydropyrimido[1,2-a]azepine (DBU; n^{o} CAS=6674-22-2).

Test n^{o} 17:

This test illustrates the invention and uses 5,850 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 800 ppm of 2,2′-diazabicyclo[2.2.2]octane (DABCO; n^{o} CAS=280-57-9).

Test n^{o} 18:

This test illustrates the invention and uses 5,850 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with a blend of amines consisting of 400 ppm of an amine of formula (I) which is N-(1-methylpropyl)-N-(2-hydroxyethylamine) and 400 ppm of 2-aminoethanol (ethanolamine; n^{o} CAS=141-43-5).

For tests n^{o} 9 to 18, the measurements of the dry extracts (DE), of the percentage by weight of particles having a diameter of less than 2 μm (%<2 μm) and of the Brookfield™ viscosities at 25° C. and at 10 revolutions/minute at t=0 (Bk10 t0) and at t=8 days after stirring (Bk10 t8) are given in table 3.

TABLE 3

| Test n° | 9 | 10 | 11 | 12 | 13 |
|---|---|---|---|---|---|
| Prior Art Invention | PA | IN | IN | IN | IN |
| Dispersant (ppm) | 6,500 | 6,500 | 5,850 | 5,850 | 5,850 |
| Amine (ppm) | 0 | 800 | 800 | 800 | 800 |
| DE (%) | 78.4 | 80 | 78.4 | 78.4 | 78.3 |
| % <2 μm | 88.3 | 88.4 | 88.4 | 88.4 | 88.3 |
| Bk10 t0 | 4,180 | 1,580 | 1,010 | 870 | 3,790 |
| Bk10 t8 | 5,500 | 1,300 | 1,070 | 840 | 3,170 |
| Test n° | 14 | 15 | 16 | 17 | 18 |
| Prior Art Invention | IN | IN | IN | IN | IN |
| Dispersant (ppm) | 5,850 | 5,850 | 5,850 | 5,850 | 5,850 |
| Amine (ppm) | 800 | 800 | 800 | 800 | 800 |
| DE (%) | 78.5 | 78.4 | 78.4 | 78.4 | 78.4 |
| % <2 μm | 88.4 | 88.4 | 88.4 | 88.4 | 88.3 |
| Bk10 t0 | 1,670 | 2,310 | 2,190 | 1,990 | 2,310 |
| Bk10 t8 | 2,550 | 2,440 | 3,040 | 2,080 | 2,100 |

By comparison between tests n^{o} 9 and 10, performed with an equivalent dose of acrylic polymer, it is shown that the amine allows grinding with a higher dry extract, whilst reducing the Brookfield™ viscosities values.

Tests n^{o} 11 to 18, by comparison with test n^{o} 9, demonstrate that by adding an amine it is possible to reduce the quantity of acrylic polymer, whilst obtaining for the same dry extract lower Brookfield viscosity values.

The best results are obtained for the amine of formula (I) according to test n^{o} 12.

Lastly, a final test n^{o} 19, outside the invention, was performed, illustrating an identical dose for the polymer and the amine (as according to document U.S. Pat. No. 4,370,171 A 1).

It uses 2,900 ppm of a homopolymer of acrylic acid, 50% by mole of the carboxylic sites of which are neutralised by the magnesium ion and 50% by the sodium ion, and of molecular weight as determined by GPC equal to 5,500 g/mole, in combination with 2,900 ppm of N-(1-methylpropyl)-N-(2-hydroxyethylamine).

It was not possible to grind with a 77% dry extract, so as to obtain 88% by weight of particles having a diameter of less than 2 μm, as in the other tests: in this case the suspension proved to be much too viscous.

### Example 4

In the following tests, a coarse carbonate is put in suspension in water at 20% by weight of concentration. This suspension is stirred to prevent any sedimentation; it circulates in a grinder of the Dyno-Mill™ type with a fixed cylinder and rotating impeller, the grinding body of which consists of 2,900 grams of corundum beads of diameter of between 0.6 mm and 1 mm.

At this step, the granulometric distribution of the particles is such that 60% by weight of them have a diameter of less than 1 micron.

The calcium carbonate is then concentrated by any means well known to the skilled man in the art until the concentration required for the application is obtained, equal to 67.5% by weight of calcium carbonate.

A filtration cake is then obtained which it is essential to redisperse in order that it becomes easily manipulated, through the use of acrylic polymer, alone, or in combination with an amine.

This very particular method, called “grinding a low concentration without a dispersant agent followed by reconcentration” is notably described in detail in document EP 2 044 159.

These filtration cake dispersion tests are performed in the presence of a copolymer of acrylic acid and of maleic anhydride, and possibly of an amine.

Test n^{o} 20:

This dispersion test illustrates the prior art; it uses 3,500 ppm of a copolymer of acrylic acid and of maleic anhydride, consisting of acrylic acid and maleic anhydride in a molar ratio r equal to 1.36:1, of molecular weight equal to 19,500 g/mole and 100% by mole of the acid groups of which are neutralised by sodium hydroxide.

Test n^{o} 21:

This test illustrates the invention and uses 3,500 ppm of the same copolymer as in test n^{o} 1, in combination with 800 ppm of N-(1-methylpropyl)-N-(2-hydroxyethylamine).

Test n^{o} 22:

This test illustrates the invention and uses 3,200 ppm of the same copolymer as in test n^{o} 1, in combination with 800 ppm of N-(1-methylpropyl)-N-(2-hydroxyethylamine).

In the case of tests n^{o} 20 to 22, the measurements of the dry extracts (DE) and of the Brookfield™ viscosities at 25° C. and at 10 revolutions/minute at t=0 (Bk10 t0) and at t=8 days after stirring (Bk10 t8) are given in table 4.

TABLE 4

| Test n° | 20 | 21 | 22 |
|---|---|---|---|
| Prior Art Invention | PA | IN | IN |
| Dispersant (ppm) | 3,500 | 3,500 | 3,200 |
| Amine (ppm) | 0 | 800 | 800 |
| DE (%) | 65.3 | 65.2 | 65.4 |
| Bk10 t0 | 310 | 160 | 200 |
| Bk10 t8 | 600 | 300 | 580 |

These results demonstrate that the addition of an amine, at a constant dose of acrylic polymer, enables the rheology of the suspension obtained to be reduced, or the quantity of acrylic dispersant to be reduced, whilst maintaining the Brookfield™ viscosity at an almost identical level.

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted. The term “mentioned” notes exemplary embodiments, and is not limiting to certain species. As used herein the words “a” and “an” and the like carry the meaning of “one or more.”

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1- A method of manufacturing an aqueous suspension of mineral matter, comprising dispersing and/or grinding said mineral matter in the presence of an amine and an acrylic polymer completely neutralized by a neutralization agent other than said amine.

2- The method according to claim 1, wherein the amine and the acrylic polymer are present in an amine:acrylic polymer mass ratio of 0.05:1 and 0.35:1.

3- The method according to claim 1, wherein the amine is selected from the group consisting of dimethylamine, monoethanolamine, diethanolamine, triethanolamine, N-methylethanolamine, 2-amino-2-methyl-1-propanol, triisopropanolamine, 2,3,4,6,7,8,9,10-octahydropyrimido[1,2-a]azepine, 2,2′-diazabicyclo[2.2.2]octane, and mixtures thereof.

4- The method according to claim 1, wherein the amine satisfies formula (I):
NR₁R₂R₃ (I)
where R₁, R₂, R₃ are identical or different, and chosen from:
hydrogen,
a linear or branched alkyl or oxyalkylated radical having 1 to 12 carbon atoms,
a cyclo-alkyl radical having 3 to 12 carbon atoms,
a linear hydroxy-alkyl radical having 1 to 6 carbon atoms,
provided that:
at most one of R₂ and R₃ represents hydrogen,
at least one of R₁, R₂, R₃ includes an OH group,
at least one of R₁, R₂, R₃ includes at least one branch in the α position of the nitrogen atom.

5- The method according to claim 4, wherein in formula (I) R₁ represents hydrogen, and R₂ and R₃ are identical or different and chosen from:
a linear or branched alkyl or oxyalkylated radical having 1 to 12 carbon atoms,
a cyclo-alkyl radical having 3 to 12 carbon atoms,
a linear hydroxy-alkyl radical having 1 to 6 carbon atoms,
provided that:
at most one of R₂ and R₃ includes an OH group,
at least one of R₂ and R₃ includes at least one branch in the α position of the nitrogen atom.

6- The method according to claim 4, where in formula (I) each alkyl, oxyalkylated and cyclo-alkyl radical includes 3 to 10 carbon atoms.

7- The method according to claim 4, wherein in formula (I) the radical or radicals carrying the OH group include 2 or 3 carbon atoms.

8- The method according to claim 4, wherein in formula (I) R₁ represents hydrogen, and R₂ and R₃ are identical or different, and chosen from:
a linear or branched alkyl or oxyalkylated radical having 3 to 8 carbon atoms,
a cyclo-alkyl radical having 6 to 10 carbon atoms,
a linear hydroxy-alkyl radical having 2 to 3 carbon atoms,
provided that:
at least one of R₂ and R₃ includes an OH group,
at least one of R₂ and R₃ includes at least one branch in the α position of the nitrogen atom.

9- The method according to claim 1, wherein the amine is selected from the group consisting of:
N-(1-methylpropyl)-N-(2-hydroxyethylamine),
N-(1,3-dimethylbutyl)-N-(2-hydroxyethylamine),
N-(1-ethyl-3-methylpentyl)-N-(2-hydroxyethylamine),
N-(3,3′,5-trimethylcyclohexyl)-N-(2-hydroxyethylamine),
N-(4-hydroxycyclohexyl)-N-(2-hydroxyethylamine), and
mixtures thereof

10- The method according to claim 1, wherein the acrylic polymer is completely neutralized by a neutralization agent selected from the group consisting of calcium hydroxide, calcium oxide, magnesium hydroxide, magnesium oxide, sodium hydroxide, potassium hydroxide, lithium hydroxide, and mixtures thereof.

11- The method according to claim 1, wherein the acrylic polymer is a homopolymer of acrylic acid.

12- The method according to claim 1, wherein the acrylic polymer is a copolymer of acrylic acid with another monomer.

13- The method according to claim 12, wherein the other monomer is selected from the group consisting of methacrylic acid, maleic anhydride, 2-acrylamido-2-methyl propane sulfonic acid, the phosphoric esters of the (meth)acrylates of alkylene glycol, the non-ionic monomers of formula (II): 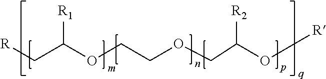
where m, n, p and q are integers and m, n, p are less than 150, q is greater than 0 and at least one integer among m, n and p is non-zero, R is a radical having a polymerizable unsaturated group, R₁ and R₂ are identical or different and represent hydrogen atoms or alkyl groups, R′ represents hydrogen or a hydrocarbonaceous radical having 1 to 40 carbon atoms, or an ionic or ionisable group, and mixtures thereof.

14- The method according to claim 1, wherein the aqueous suspension, after dispersion and/or grinding, has a dry extract, expressed as a percentage by dry weight of mineral matter compared to its total weight, of 10%-82%.

15- The method according to claim 14, wherein the aqueous suspension, after dispersion and/or grinding, has a dry extract, expressed as a percentage by dry weight of mineral matter compared to its total weight, of 65%-78%.

16- The method according to claim 1, wherein the aqueous suspension, after dispersion and/or grinding, has a dry weight content of acrylic polymer, compared to the total dry weight of mineral matter, of 0.01%-5.00%.

17- The method according to claim 1, wherein the aqueous suspension, after dispersion and/or grinding, has a dry weight content of acrylic polymer, compared to the total dry weight of mineral matter, of 0.05%-1.00%.

18- The method according to claim 1, wherein the mineral matter is selected from the group consisting of natural, synthetic or precipitated calcium carbonate, talc, kaolin and mixtures thereof.

19- The method according to claim 1, wherein the mineral matter is natural calcium carbonate.

20- The method according to claim 1, wherein the amine and the acrylic polymer are present in an amine:acrylic polymer mass ratio of 0.10:1-0.25:1.
